(19) United States
(12) Patent Application Publication
(10) Pub. No.: US 2026/0142253 A1
(43) Pub. Date: May 21, 2026

(54) ON-BOARD ELECTRICAL SYSTEM FOR A MOTOR VEHICLE AND MOTOR VEHICLE

(71) Applicant: HOLON GmbH, Paderborn (DE)

(72) Inventors: Erik WRAGE, Paderborn (DE); Hendrik REINEKE, Bad Driburg (DE); Manoj KURUGODU, Lippstadt (DE); Ullrich HAMMELMAIER, Paderborn (DE)

(21) Appl. No.: 19/392,140

(22) Filed: Nov. 18, 2025

(30) Foreign Application Priority Data
Nov. 19, 2024 (EP) 24213958.2

(51) Int. Cl. H01M 10/42; B60L 50/64; B60L 58/12; B60L 58/18

(52) U.S. Cl. CPC H01M 10/425; B60L 50/64; B60L 58/12; B60L 58/18; B60L 2210/10; H01M 2220/20

(57) ABSTRACT

An on-board electrical system for a motor vehicle. The on-board electrical system includes a high-voltage electrical system and a low-voltage electrical system. The high-voltage electrical system has a high-voltage battery as a primary energy source of the high-voltage electrical system, and the low-voltage electrical system has a low-voltage battery as the primary energy source of the low-voltage electrical system. Furthermore, the on-board electrical system further includes a motor vehicle with a corresponding on-board electrical system.

### RELATED APPLICATIONS

The present application claims priority of European Application Number 24213958.2 filed Nov. 19, 2024, the disclosure of which is hereby incorporated by reference herein in its entirety.

### FIELD

The present disclosure relates to an on-board electrical system for a motor vehicle. The present disclosure further relates to a motor vehicle having an on-board electrical system.

### BACKGROUND

An on-board electrical system of a motor vehicle is an electrical system that supplies all electrical components and consumers in the vehicle with electrical energy. The on-board electrical system distributes the electrical energy within a defined voltage range. In electric and hybrid vehicles, the on-board electrical system includes a high-voltage electrical system and a low-voltage electrical system. The high-voltage electrical system is operated in a voltage range between 60 V and 850 V, while the low-voltage electrical system has a voltage between 12 V and 48 V. The high-voltage electrical system serves to supply the drive system and some drive-related ancillary units with electrical energy, while the low-voltage electrical system supplies safety-relevant components, such as steering and braking systems, as well as other electrical consumers, such as an air conditioning system, an infotainment system or a seat heating system, with electrical energy.

The high-voltage electrical system of corresponding on-board electrical systems has a high-voltage battery as a primary energy source of the high-voltage electrical system. A primary energy supply of the low-voltage electrical system is also provided via the high-voltage battery. For this purpose, the high-voltage electrical system is coupled to the low-voltage electrical system via a DC-DC converter.

Corresponding systems are described, for example, in WO 2024 068 065 A1 and DE 10 2013 225 097 A1. The on-board electrical systems shown here are designed, for example, in such a way that the consumers connected to the low-voltage electrical system are able to be supplied with electrical energy from the high-voltage battery via the DC-DC converter even when the vehicle is in standby mode. This means that a battery is no longer required in the entire low-voltage electrical system.

However, providing the energy required for the low-voltage electrical system via the high-voltage battery of the high-voltage electrical system also has disadvantages. In electrically powered motor vehicles, and especially in autonomous motor vehicles, the consumers connected to the low-voltage electrical system is able to consume up to 50% of the high-voltage battery capacity when the motor vehicle is in operation. This has a negative impact on the range of the motor vehicles, as the high-voltage battery supplies the drive train with electrical energy.

A way to increase the range of corresponding motor vehicles is to increase the capacity of the high-voltage battery, for example by adding additional battery modules. However, this entails several disadvantages. Additional high-voltage battery modules have a significant weight, which has a counterproductive effect on the weight of the motor vehicle and thus its range. Due to the mechanical and thermal requirements, heavy weight enclosures and cooling systems are also required. Furthermore, protective measures regarding high-voltage safety are observed in order to ensure active and passive user protection in the event of failures. Last but not least, the inclusion of additional battery modules is limited by the limited space available within the motor vehicle.

DE 10 2023 110 856 A1 describes an on-board electrical system for an electric vehicle, which is formed from a high-voltage electrical system and a low-voltage electrical system. Both the low-voltage electrical system and the high-voltage electrical system are connected to an on-board charger, via which the batteries of the respective electrical systems are able to be charged.

EP 3 616 971 A1 describes an on-board electrical system for an electric vehicle, which includes three low-voltage electrical systems, each has its own battery and connected to a high-voltage battery by means of DC-DC converters.

DE 10 2012 011 840 A1 describes an on-board electrical system for a motor vehicle includes at least one high-voltage network, at least one low-voltage network, and at least one first and at least one second electrical converter device connected between the high-voltage energy storage device and the low-voltage energy storage device.

The object of the present disclosure is to provide an improved on-board electrical system for a motor vehicle which ensures a sufficient supply of electrical energy to the low-voltage electrical system and at the same time enables an increase in the range of the motor vehicle without increasing the capacity of the high-voltage battery.

Furthermore, the object of the present disclosure is to provide a motor vehicle with a corresponding on-board electrical system.

The first part of the object is achieved by an on-board electrical system for a motor vehicle. The second part of the object is achieved by a motor vehicle with an on-board electrical system.

The on-board electrical system according to the present disclosure is designed as an on-board electrical system for a motor vehicle, for example, for an electric motor-driven motor vehicle. In this context, an electric motor-driven motor vehicle is a vehicle that has either a hybrid drive (such as the combination of an electric motor and a combustion engine, for example, micro hybrids, mild hybrids or plug-in hybrids) or a purely electric drive. In at least some embodiments, the motor vehicle is an at least partially autonomously driving, electric motor-driven motor vehicle.

The on-board electrical system includes a high-voltage electrical system and a low-voltage electrical system. The high-voltage electrical system defines a part of the on-board electrical system, which is supplied with a voltage of 60 V to 850 V. The high-voltage electrical system usually comprises the electrical components required for electric driving.

The low-voltage electrical system refers to the part of the on-board electrical system that is operated with a voltage between 12 V and 48 V. The two electrical system regions therefore have different voltage levels.

Smaller electrical consumers, such as the vehicle's air conditioning, infotainment or seat heating, are connected to the low-voltage electrical system. Safety-relevant consumers that ensure reliable driving, such as components of the steering and braking functions, are also connected to the low-voltage electrical system.

The high-voltage electrical system has a high-voltage battery as the primary energy source. In the context of the present disclosure, the primary energy source refers to the energy source that supplies the corresponding part of the on-board electrical system with electrical energy during normal operation of the motor vehicle.

According to the present disclosure, in the on-board electrical system, the low-voltage electrical system has a low-voltage battery as the primary energy source. In contrast to on-board electrical systems from other references, the low-voltage electrical system draws its primary energy required during normal operation of the motor vehicle directly from the low-voltage battery and not via a DC-DC converter that is connected to the high-voltage electrical system and thus to the high-voltage battery. This has the advantage that the electrical energy required for the low-voltage electrical system is not drawn from the high-voltage battery. Thus, the energy stored in the high-voltage battery is able to be used exclusively for the consumers connected to the high-voltage electrical system, for example, the drive train. The range of the vehicle is therefore not reduced by the consumers connected to the low-voltage electrical system. Consequently, the range of the motor vehicle is able to be increased by increasing the capacity of the low-voltage battery without requiring an increase in the capacity of the high-voltage battery.

Compared to high-voltage batteries installed in motor vehicles, the use of low-voltage batteries is also able to save weight. Due to the lower crash requirements, the housing of the low-voltage batteries is able to be made lighter than the housing of high-voltage batteries. In addition, cooling is not required for low-voltage batteries, which also contributes to weight reduction. A further advantage is that, unlike high-voltage batteries, low-voltage batteries are not homologated according to ECE R100, since low-voltage batteries only supply auxiliary consumers and not the drive train. Low-voltage batteries are still able to be placed in the vehicle independently of the high-voltage batteries, so that the available installation space of the motor vehicle is able to be used as efficiently as possible.

In at least some embodiments, the low-voltage electrical system has a first electrical subsystem and a second electrical subsystem, wherein the first electrical subsystem is formed from a main electrical system and a redundancy electrical system. The first electrical subsystem of the low-voltage electrical system is, for example, connected to the motor vehicle's safety-relevant consumers. Safety-relevant consumers are those consumers that are necessary to ensure reliable driving operation, for example, semi-autonomous driving operation of the motor vehicle. These include, for example, consumers that are integrated into the steering and braking functions of the motor vehicle. In at least some embodiments, the corresponding consumers are located in both the main electrical system and the redundancy electrical system or are connected to both electrical systems. This has the advantage that in the event of a failure of the main electrical system, the consumers arranged in the redundancy electrical system and connected thereto is able to take over the safety-relevant functions identically, for example, for semi-autonomously driving vehicles, as manual intervention by a driver is not possible.

In at least some embodiments, the second electrical subsystem is connected to the non-safety-relevant consumers. The non-safety-relevant consumers of the motor vehicle are, for example, comfort functions, such as a navigation system, an air conditioning system or a seat heating system. Since a failure of these consumers does not directly affect safe and reliable driving operation, no additional redundancy electrical system is required for these consumers.

The low-voltage battery is connected to a DC-DC converter via a disconnecting element, for example, a switch, wherein the DC-DC converter is connected to the high-voltage electrical system. The DC-DC converter is hereinafter referred to as the first DC-DC converter. The first DC-DC converter is a DC-DC converter which is designed to convert the voltage of the high-voltage electrical system into or to a voltage value of the low-voltage electrical system. In response to the low-voltage battery being connected to the high-voltage electrical system via the first DC-DC converter, the low-voltage battery is charged via the high-voltage battery.

In at least some embodiments, the on-board electrical system includes a control unit, wherein the control unit activates the disconnecting element when a release condition is met and releases the connection between the low-voltage electrical system and the first DC-DC converter. The release condition is met, for example, when the high-voltage battery is connected to a charging infrastructure and is being charged. This means that the low-voltage battery is also able to be charged during the regular charging process of the high-voltage battery without the need for an additional charging connection.

The release condition is also able to be met in response to the charge level of the low-voltage battery falling below a defined threshold. The threshold is able to, for example, be 10% of the total capacity of the low-voltage battery, which enables the low-voltage battery to be charged via the high-voltage battery when a critical charge level is reached while the vehicle is in operation. This ensures that the consumers connected to the low-voltage electrical system are supplied with sufficient electrical energy at all times.

In at least some embodiments of the present disclosure, the low-voltage battery is coupled to the second electrical subsystem and serves as its primary energy source. In this way, all non-safety-relevant consumers of the motor vehicle is able to be supplied with electrical energy from the low-voltage battery via the second electrical subsystem, without putting a strain on the high-voltage battery.

In this case, the first electrical subsystem is able to be connected to the high-voltage electrical system via a second DC-DC converter and/or have a second low-voltage battery that is connected to the high-voltage electrical system via the second DC-DC converter. In at least this embodiment, the safety-relevant consumers of the motor vehicle are supplied with electrical energy from the high-voltage battery of the high-voltage electrical system via the second DC-DC converter. The high capacity of the high-voltage battery ensures that safety-relevant consumers are supplied with sufficient electrical energy at all times.

In at least some embodiments, the high-voltage electrical system has a voltage of 400 V, the first electrical subsystem has a voltage of 12 V, and the second electrical subsystem has a voltage of 24 V.

In at least some embodiments, the low-voltage battery has a capacity of 15 kWh to 25 kWh, for example, 20 kWh. With a corresponding capacity, a sufficient energy supply to the non-safety-relevant consumers is able to be ensured and at the same time the range of the motor vehicle is able to be significantly increased, provided that the capacity of the high-voltage battery, which supplies the non-safety-relevant consumers with electrical energy in corresponding on-board electrical systems known from the other references, is not changed.

In at least some embodiments, the electrical capacity of the low-voltage battery designed as the primary energy source corresponds to 20 to 40%, for example, 25 to 35% of the electrical capacity of the high-voltage battery.

In at least some embodiments of the present disclosure, a motor vehicle is equipped with an on-board electrical system.

### BRIEF DESCRIPTION OF THE DRAWING

The present disclosure is described in more detail hereinafter by means of an exemplary embodiment illustrated in the figure.

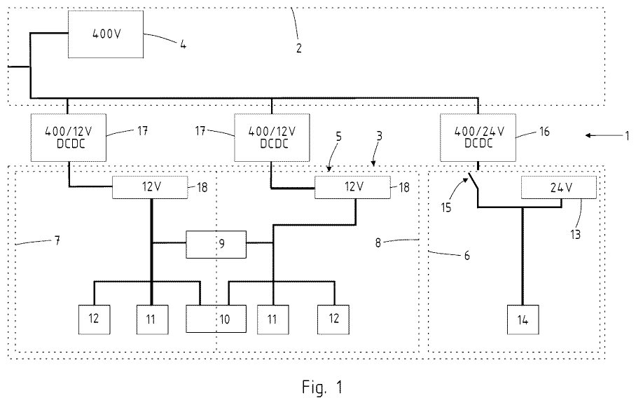

The figure (FIG. 1) shows a schematic representation of a circuit diagram of an on-board electrical system according to at least one embodiment of the present disclosure.

### DETAILED DESCRIPTION

The on-board electrical system 1 according to the present disclosure for a motor vehicle, which is not shown here, comprises a high-voltage electrical system 2 and a low-voltage electrical system 3. The high-voltage electrical system 2 has a high-voltage battery 4 as the primary energy source of the high-voltage electrical system 2. The high-voltage electrical system 2 operates with a voltage of 400 V. The high-voltage electrical system 2 operates the components of the motor vehicle required for electric driving, for example, the drive train, which is not shown here.

The low-voltage electrical system 3 has a first electrical subsystem 5 and a second electrical subsystem 6, wherein the first electrical subsystem 5 is formed from a main electrical system 7 and a redundancy electrical system 8.

The first electrical subsystem 5 is operated with a voltage of 12 V and the second electrical subsystem 6 with a voltage of 24 V.

According to ISO 26262:2018, for example, the safety-relevant consumers 9, 10, 11 of the motor vehicle are coupled to the first electrical subsystem 5 of the low-voltage electrical system 3. Safety-relevant consumers such as an automated driving system 9 or steer-by-wire 10 are connected to both the main electrical system 7 and the redundancy electrical system 8, so that in the event of a failure of one of these electrical systems, the other electrical system is able to take over the energy supply to the consumers 9, 10. Other safety-relevant consumers, such as an electronic braking system 11, are arranged in both the main electrical system 7 and the redundancy electrical system 8, so that in the event of a failure of one of the electrical systems, the safety-relevant consumer 11 is able to fulfill its function in the other electrical system. Non-safety-relevant consumers 12 with a low energy demand is also able to be coupled to the first electrical subsystem 5.

According to the present disclosure, the low-voltage electrical system 3 has a low-voltage battery 13 as the primary energy source. The low-voltage battery 13 is connected to the second electrical subsystem 6 and supplies the second electrical subsystem 6 with electrical energy during normal operation of the motor vehicle. Non-safety-relevant consumers 14 of the motor vehicle, which have a high energy demand, are connected to the second electrical subsystem 6. In at least some embodiments, non-safety-relevant consumers 14 includes components such as the air conditioning system or comfort functions such as infotainment or seat heating. In at least some embodiments, in autonomously operated vehicles, these components consume a significant proportion of the energy normally provided by the high-voltage battery 4. This in turn has a negative impact on the range of the motor vehicles, as the high-voltage battery 4 also supplies the drive train of the motor vehicle with electrical energy. By integrating the low-voltage battery 13 into the low-voltage electrical system 3 and here, for example, into the second electrical subsystem 6 according to the present disclosure, the non-safety-relevant consumers 14 of the motor vehicle with a high energy demand are supplied with the required electrical energy directly via the low-voltage battery 13 during normal operation of the vehicle. Thus, the energy stored in the high-voltage battery 4 is able to be advantageously used exclusively for the consumers connected to the high-voltage electrical system 2, for example, the drive train. This is able to increase the range of the motor vehicle.

The low-voltage battery 13 is connected to a first DC-DC converter 16, also called a DC-DC converter, via a disconnecting element 15, for example, a switch, wherein the first DC-DC converter 16 is connected to the high-voltage electrical system 2.

The on-board electrical system 1 comprises a control unit, which is not shown here, wherein the control unit activates the disconnecting element 15 when a release condition is met and releases the connection between the low-voltage electrical system 3 and the first DC-DC converter 16 such that the low-voltage battery 13 is charged via the high-voltage electrical system 2. The release condition is met, for example, during a charging process of the high-voltage battery 4 and/or when a charge level of the low-voltage battery 13 of less than or equal to 10% is reached. In response to the high-voltage battery 4 being connected to a charging electrical system, the low-voltage battery 13 is also charged via the first DC-DC converter 16. Therefore, no additional charging connection is required for the low-voltage battery 13. In at least some embodiments, the low-voltage battery 13 via the high-voltage battery 4 is also able to be charged when a critical charge level of the low-voltage battery 13 is reached while the motor vehicle is in operation, which ensures that the consumers 14 connected to the low-voltage electrical system 3 are supplied with sufficient electrical energy at all times.

The main electrical system 7 and the redundancy electrical system 8 are each connected to the high-voltage electrical system 2 via a second DC-DC converter 17. The consumers 9, 10, 11, 12 connected to the first electrical subsystem 5 are supplied with electrical energy directly via the high-voltage electrical system 2 via the second DC-DC converters 17. The high capacity of the high-voltage battery 4 thus ensures that, for example, the safety-relevant consumers 9, 10, 11 are supplied with sufficient electrical energy at all times.

Both the main electrical system 7 and the redundancy electrical system 8 each have a second low-voltage battery 18. The second low-voltage batteries 18 are not used for the primary energy supply, but are able to supply electrical energy in the stand-by mode of the motor vehicle to the consumers connected to the first electrical subsystem 5, which remain active when the motor vehicle is in stand-by. The second low-voltage batteries 18 therefore serve only as a secondary supply and not as a primary energy source.

1. An on-board electrical system for a motor vehicle, comprising:
a high-voltage electrical system; and
a low-voltage electrical system,
wherein
the high-voltage electrical system has a high-voltage battery as a primary energy source of the high-voltage electrical system, and components of the motor vehicle required for electrical driving are operable via the high-voltage electrical system,
the low-voltage electrical system has a low-voltage battery as a primary energy source of the low-voltage electrical system, wherein the low-voltage battery is connected to a first DC-DC converter via a disconnecting element, and
the first DC-DC converter is connected to the high-voltage electrical system.

2. The on-board electrical system according to claim 1, wherein
the low-voltage electrical system has a first electrical subsystem and a second electrical subsystem, and
the first electrical subsystem has a main electrical system and a redundancy electrical system.

3. The on-board electrical system according to claim 1, wherein
the on-board electrical system further comprises a control unit, and
the control unit is configured to activate the disconnecting element in response to a release condition being met and and to connect between the low-voltage electrical system and the first DC-DC converter such that the low-voltage battery is charged.

4. The on-board electrical system according to claim 3, wherein
the release condition is met during a charging process of the high-voltage battery, or in response to a defined charge state of the low-voltage battery being undershot, and
the defined charge state is 10% of a total capacity of the low-voltage battery.

5. The on-board electrical system according to claim 2, wherein the low-voltage battery is connected to the second electrical subsystem and is configured to serve as the primary energy source of the second electrical subsystem.

6. The on-board electrical system according to claim 2, wherein
the first electrical subsystem is connected to the high-voltage electrical system via a second DC-DC converter, or
the first electrical subsystem has a further low-voltage battery which is connected to the high-voltage electrical system via the second DC-DC converter.

7. The on-board electrical system according to claim 2, wherein the high-voltage electrical system has a voltage of 400 V, the first electrical subsystem has a voltage of 12 V, and the second electrical subsystem has a voltage of 24 V.

8. The on-board electrical system according to claim 1, wherein the low-voltage battery has a capacity of 15 to 25 kWh.

9. The on-board electrical system according to claim 1, wherein an electrical capacity of the low-voltage battery corresponds to 20 to 40% of an electrical capacity of the high-voltage battery.

10. A motor vehicle comprising:
an on-board electrical system,
wherein the on-board electrical system comprises:
a high-voltage electrical system; and
a low-voltage electrical system,
wherein
the high-voltage electrical system has a high-voltage battery as a primary energy source of the high-voltage electrical system, and components of the motor vehicle required for electrical driving are operable via the high-voltage electrical system,
the low-voltage electrical system has a low-voltage battery as a primary energy source of the low-voltage electrical system, wherein the low-voltage battery is connected to a first DC-DC converter via a disconnecting element, and
the first DC-DC converter is connected to the high-voltage electrical system.

11. The on-board electrical system according to claim 3, wherein
the release condition is met during a charging process of the high-voltage battery, and in response to a defined charge state of the low-voltage battery being undershot, and
the defined charge state is 10% of a total capacity of the low-voltage battery.

12. The on-board electrical system according to claim 2, wherein
the first electrical subsystem is connected to the high-voltage electrical system via a second DC-DC converter, and
the first electrical subsystem has a further low-voltage battery which is connected to the high-voltage electrical system via the second DC-DC converter.

13. The on-board electrical system according to claim 1, wherein the low-voltage battery has a capacity of 20 to 22 kWh.

14. The on-board electrical system according to claim 1, wherein an electrical capacity of the low-voltage battery corresponds to 25 to 35% of an electrical capacity of the high-voltage battery.
